(19) United States
(12) Patent Application Publication
(10) Pub. No.: US 2010/0218087 A1
(43) Pub. Date: Aug. 26, 2010

(54) Adaptive Response/Interpretive Expression, Communication Distribution, and Intelligent Determination System and Method

(76) Inventor: Mark R Knobel, Miami, FL (US)

Correspondence Address: Flindt Intellectual Property Law Group, PLLC, P.O. Box 1390, Issaquah, WA, 98027-0057, US

(21) Appl. No.: 12/738,840

(22) PCT Filed: Oct. 17, 2008
(86) PCT No.: PCT/US08/80385

§ 371 Date: Apr. 19, 2010

Related U.S. Application Data
(63) Continuation of application No. 11/975,373, filed on Oct. 17, 2007.

(51) Int. Cl. G06F 3/14; G06F 15/16

(52) U.S. Cl. 715/236; 709/217

(57) ABSTRACT

Prestimulus and/or Post-event cognitive processing preferences of individuals are identified and classified to develop informational content that appeals in substance and format to those individuals identified according to the identification and classification process. Versioning of content by tagging content in all media forms, such as print, audio, and visual is conducted in accordance to classifications of cognitive processing preferences of individual users. Versioned content is automatically matched to individual preferences of a requesting individual or system prior to distribution.

### CROSS-REFERENCE TO RELATED APPLICATION

This application claims the priority of U.S. patent application Ser. No. 11/975,373 originally filed Oct. 17, 2007 and entitled “Adaptive Response/Interpretive Expression, Communication Distribution, and Intelligent Determination System and Method”.

### TECHNICAL FIELD

Embodiments of the present invention relate to various forms of informational and interpersonal communications. More particularly, the embodiments of the present invention relate to determining individual stylization guidelines to optimize recipient comprehension, absorption, retention and/or responses to messages and developing and/or delivering custom content messages in various media forms according to the individual stylization guidelines.

### BACKGROUND

In the age of information, industry recognizes the value that successful communication delivers to an organization and its related ventures. More specifically, the ability to understand and to communicate with a target audience, such as employees or consumers, often determines the success or failure of a project and/or product. Qualitative metrics use relative awareness, understanding, and satisfaction to evaluate relative effectiveness of communication with a target audience. Quantitative metrics use productivity, turnover, monitored behavior change, and achievement of business goals to evaluate relative effectiveness of communication with the target audience, Unfortunately, existent efforts to achieve better informational communications often fail to identify practices for measuring communications with individuals within the target audience and further fail to articulate potential modifications to the prior and/or subsequent communications for that individual.

In an effort to address these difficulties, some communication methods use more focused evaluation tools, such as a psychological assessment. Accordingly, a communication method using such psychology-based tools characterizes each target group based on the assumption that the group possesses varying degrees of similarity to defined psychological categories. Resultant information to be communicated is tailored to match a predisposition of the target group to receive materials. Unfortunately, even having communications addressing predispositions of the target group do not optimize individual recipient comprehension, absorption, retention and/or responses within the target audience.

### BRIEF DESCRIPTION OF THE DRAWINGS

Non-limiting and non-exhaustive exemplary embodiments of the present disclosure are described with reference to the following drawings in which:

FIG. 1 illustrates a block diagram of a portion of an adaptive response/interpretive expression, communication distribution, and intelligence systems environment coupled with different network components, including a versioning platform server, in accordance with at least one embodiment of the present disclosure;

FIG. 2 illustrates a block diagram of a portion of a multi-mode versioning platform system, in accordance with at least one embodiment of the present disclosure;

FIG. 3 illustrates a block diagram of a portion of a versioning platform system as presented in FIG. 1 in further detail, in accordance with various embodiments of the present disclosure;

FIG. 4 illustrates a graph diagram view of elicited intent based on a response to communication relative to actual content of the communication as presented in FIG. 1 in further detail, in accordance with various embodiments of the present disclosure;

FIG. 5 illustrates a graph diagram view of content stylization modeling effectiveness based on a user's degree of understanding relative to a user's degree of relevance communication as presented in FIG. 1 in further detail, in accordance with various embodiments of the present disclosure;

FIG. 6 illustrates a block diagram of a communication versioning platform system as presented in FIG. 1 in further detail, in accordance with various embodiments of the present disclosure;

FIG. 7 illustrates a block diagram of a user versioning platform system as presented in FIG. 1 in further detail, in accordance with various embodiments of the present disclosure;

FIG. 8 illustrates a block diagram of a user versioning server as presented in FIG. 1 in further detail, in accordance with various embodiments of the present disclosure;

FIG. 9 illustrates a block diagram of a portion of the operations of a host platform a multi-mode versioning platform system as presented in FIG. 1 in further detail, in accordance with various embodiments of the present disclosure;

FIG. 10 illustrates a flow diagram view of a portion of the operations of a remote device as presented in FIG. 1 in further detail, in accordance with various embodiments;

FIG. 11 illustrates a flow diagram view of a portion of the operations of a host platform as presented in FIG. 1 in further detail, in accordance with various embodiments;

FIG. 12 illustrates a block diagram of a portion of the operations of an automated host platform as presented in FIG. 1 in further detail, in accordance with various embodiments;

FIG. 13 illustrates a block diagram of a portion of the operations of an automated content filter as presented in FIG. 1 in further detail, in accordance with various embodiments;

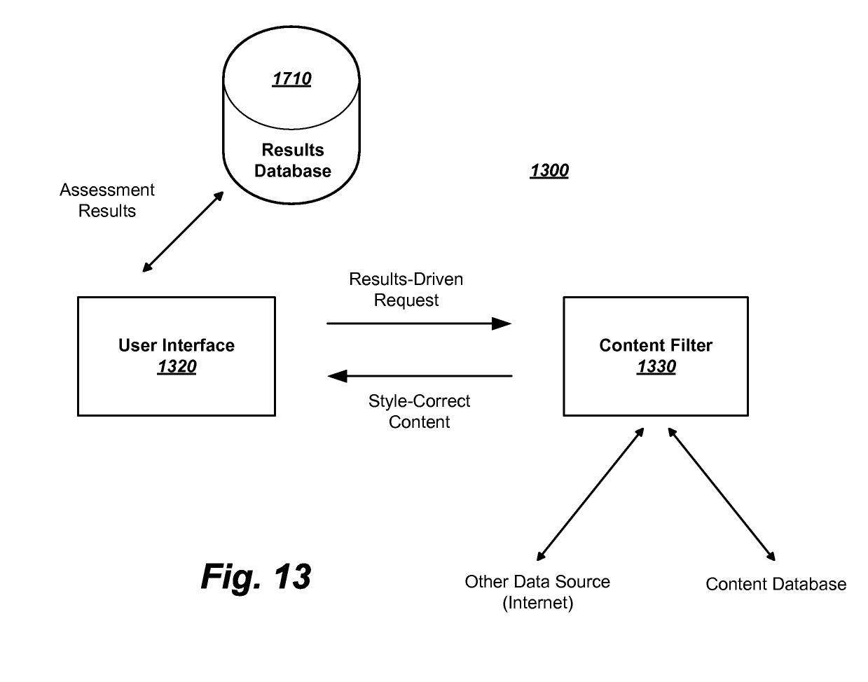

FIG. 14 illustrates a block diagram of a portion of the operations of an information filter and automated versioning engine as presented in FIG. 1 in further detail, in accordance with various embodiments;

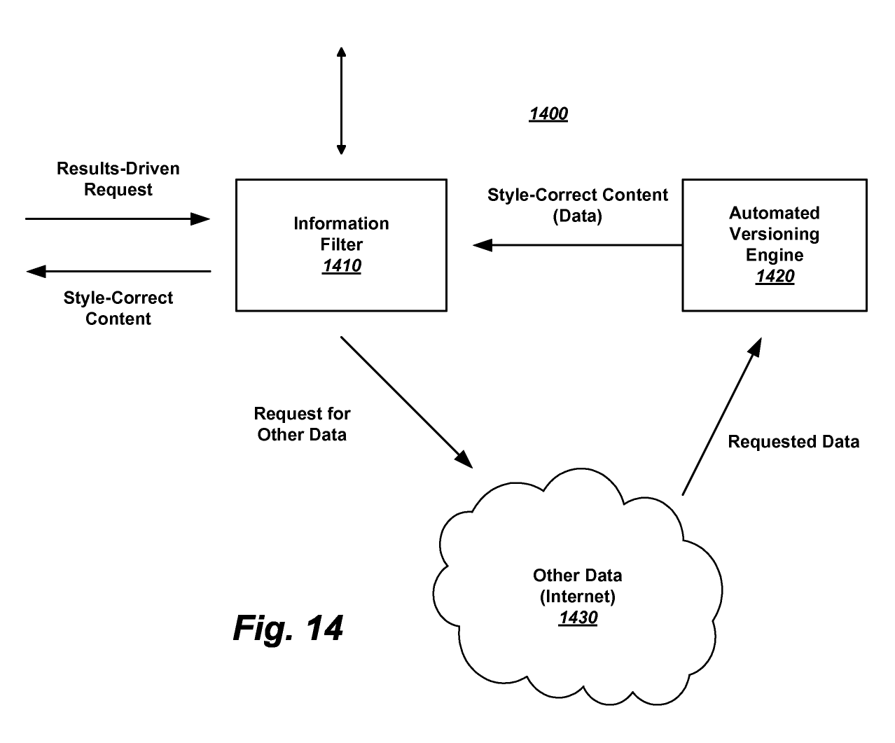

FIG. 15 illustrates a flow diagram of adaptive response/interpretive expression, communication distribution, and intelligence systems for human resource training, in accordance with at least one embodiment;

FIG. 16 illustrates a flow diagram of adaptive response/interpretive expression, communication distribution, and intelligence systems for organizational development (template request & fulfillment), in accordance with at least one embodiment;

FIG. 17 illustrates a flow diagram of adaptive response/interpretive expression, communication distribution, and intelligence systems for personal growth, in accordance with at least one embodiment;

FIG. 18 illustrates a flow diagram of adaptive response/interpretive expression, communication distribution, and intelligence systems for consumer direct marketing, in accordance with at least one embodiment; and

FIG. 19 illustrates a block diagram of a portion of an adaptive response/interpretive expression, communication distribution, and intelligence systems environment coupled with different network components, including a centralized versioning platform server, in accordance with at least one embodiment of the present disclosure;

FIG. 20 illustrates a block diagram of a user by way of Interactive voice response inputs associated product request based on previous criteria to a data clearinghouse of a versioning platform system as presented in FIG. 1 in further detail, in accordance with various embodiments of the present disclosure;

FIG. 21 illustrates a block diagram of a user by way of smart card inputs associated product request based on previous criteria to a data clearinghouse of a versioning platform system as presented in FIG. 1 in further detail, in accordance with various embodiments of the present disclosure;

FIG. 22 illustrates a block diagram of smart card data clearinghouse of a versioning platform system as presented in FIG. 1 in further detail, in accordance with various embodiments of the present disclosure;

FIG. 23 illustrates a block diagram of a user by way of smart card inputs associated product request based on previous criteria to a data clearinghouse of a versioning platform system as presented in FIG. 1 in further detail, in accordance with various embodiments of the present disclosure;

FIG. 24 illustrates a block diagram of live two way communication of a versioning platform system as presented in FIG. 1 in further detail, in accordance with various embodiments of the present disclosure; and

FIG. 25 illustrates a block diagram of a user of a versioning platform system as presented in FIG. 1 in further detail, in accordance with various embodiments of the present disclosure.

### DETAILED DESCRIPTION

Briefly stated, embodiments of the invention provide adaptive response/interpretive expression, communication distribution, and intelligence systems and methods that overcome the hereinafore-mentioned disadvantages of the heretofore-known devices of this general type and that provide a methodology and system for identifying and classifying pre-stimulus and/or post-event cognitive processing preferences in individuals; developing informational content in all media forms, such as print, audio, visual, etc., that appeal in substance and format to those individuals identified according to the classification; and versioning content according to said classification of cognitive processing preferences to individual users by tagging content and automatically matching content to individual preferences. The process further incorporates a hierarchy of communication and heuristic learning principles that, when intermingled with the content delivery methods and software and web-based applications, converts ordinary thinking routines into an altered form of content enhancement tools capable of assisting the mind of a designated individual and increasing the capacity for streamlined improvement in thought, communication, learning, and behavior with the designated individual. The unique editorial method for developing stylized content objects according to at least one corresponding cognitive type, a process referred to as Content Versioning, is used for subsequent sorting (tagging) and classification in the system. The underlying principles of content versioning may be readily applied to communications in a variety of industries including, but not limited to, educational instruction, consumer direct marketing, human resource training, organizational development, personal growth, and the like.

Various embodiments, described below, have been developed in response to the current state of the art and, in particular, in response to the previously identified problems and needs of informational and interpersonal communications that have not been fully or completely solved by currently available learning and communication systems and apparatus for stylized media content distribution. Various embodiments of the present invention include, but are not limited to, methods related to versioning communication data into stylized content according to stylization guidelines established for adaptive response/interpretive expression systems, communication distribution systems, and/or intelligent systems equipped to practice the method or aspects thereof, Versioning the underlying content may be readily applied to communications in a variety of industries including, but not limited to, educational instruction, consumer direct marketing, human resource training, organizational development, personal growth, and the like.

In the following detailed description, reference is made to the accompanying drawings which form a part hereof wherein like numerals designate like parts throughout, and in which are shown, by way of illustration, specific embodiments in which the disclosure may be practiced. It is to be understood that other embodiments may be utilized and structural or logical changes may be made without departing from the scope of the present disclosure. Therefore, the following detailed description is not to be taken in a limiting sense, and the scope of the present disclosure is defined by the appended claims and their equivalents.

Parts of the description will be presented in terms such as data, events, partitions, subspace boundaries and the like, consistent with the manner commonly employed by those skilled in the art to convey the substance of their work to others skilled in the art. As well understood by those skilled in the art, information may take the form of electric, magnetic, RF, or optic signals capable of being maintained, stored, transferred, combined, and otherwise manipulated through electrical and/or optical components of a processor and its subsystems.

The description will be presented in sections. Employment of section labels is to facilitate ease of understanding, and is not to be construed as limiting on the invention. Various operations will be described as multiple discrete steps in turn, in a manner that is most helpful in understanding the present invention; however, the order of description should not be construed as to imply that these operations are necessarily order dependent. In particular, these operations need not be performed in the order of presentation.

Throughout the specification and claims, the following terms take at least the meanings explicitly associated herein, unless the context clearly dictates otherwise. The meanings identified below are not intended to limit the terms, but merely provide illustrative examples for use of the terms. The meaning of “a,” “an,” and “the” may include reference to both the singular and the plural. Reference in the specification to “one embodiment” or “an embodiment” means that a particular feature, structure, or characteristic described in connection with the embodiment is included in at least one embodiment of the disclosure. The meaning of “in” may include “in” and “on.” The appearances of the phrases “in one embodiment” or “in an embodiment” in various places in the specification do not necessarily all refer to the same embodiment, but it may. The term “connected” may mean a direct electrical, electro-magnetic, mechanical, logical, or other connection between the items connected, without any electrical, mechanical, logical or other intermediary therebetween. The term “coupled” can mean a direct connection between items, an indirect connection through one or more intermediaries, or communication between items in a manner that may not constitute a connection. The term “circuit” or “circuitry” as used in any embodiment described herein, can mean a single component or a plurality of components, active and/or passive, discrete or integrated, that are coupled together to provide a desired function and may include, for example, singly or in any combination, hardwired circuitry, programmable circuitry, state machine circuitry, and/or firmware that stores instructions executed by programmable circuitry. The term “signal” can mean at least one current, voltage, charge, data, or other such identifiable quantity.

In an effort to clarify comparative phrases used in the specification and the claims of this disclosure, please note that the following phrases take at least the meanings indicated and associated herein, unless the context clearly dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(A B) or (B)”, that is “A” is optional. The use of any of these phrases does not imply or indicate that the particular feature, structure, or characteristic being described is a necessary component for every embodiment for which such a description is included.

Reference in the specification to “computer readable medium” as used in the instant application, includes any mechanism that provides (i.e., stores and/or transmits) information in a form readable by a machine (e.g., a computer). For example, a machine accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc. Reference in the specification to a “digital device” means that a particular feature, structure, or characteristic; namely, the device facilitated content stylization or the ability for the device to be configured to perform various versioning functions, is included in at least one embodiment of the digital device as used herein. Typically, digital devices may include general and/or special purpose computing devices, such as a server, a digital music player (MP3), a workstation, a desktop and/or laptop computer, a personal digital assistant (PDA), a mobile phone, and/or console suitably configured for practicing the present invention in accordance with at least one embodiment. The terms “client” and “host” device/platform are often synonymously used herein and are interchangeable with digital device as previously defined. Reference in the specification to “remote device” means a network device electronically coupled to the digital device or host platform via a network interface and suitably configured for practicing the present invention in accordance with at least one embodiment. Network devices may include general and/or special purpose computing devices, such as a remote core dump repository, a network access policy decision point (PDP), a Policy Enforcement Point (PEP), a gateway, a router, a bridge, a switch, a hub, a repeater, a server, and/or other adaptive response/interpretive expression communication distribution and intelligence systems.

With the features of at least one embodiment of the invention in view, there is additionally provided a computer readable medium having computer program code embodied therein for causing one or more electronic computer systems to provide information, said computer program code including program code configured to cause a computer to determine a learning type of a user, program cod configured to cause a computer to store an indication of the learning type of the user in a set of one or more predetermined directories within a user database, program code configured to cause a computer to match the stored learning type of the user within the user database with versioned objects for the stored learning type, and program code configured to cause a computer to load versioned objects corresponding to the learning type of the user.

In accordance with another feature of an embodiment of the invention, the versioned objects are stored within a content database of the stored learning type, In accordance with yet another feature of an embodiment of the invention, the content database is a remote database on one or more remote electronic computer systems in communication with the one or more electronic computer systems executing the computer program code.

In accordance with an additional feature of an embodiment of the invention, there is provided program code configured to analyze generic data in accordance with assessment parameters of stylization guidelines for available learning types, program code configured to tag the data according to each stylization guideline, and program code configured to generate versioned objects from the tagged data based in part on at least one stylization guideline. In accordance with yet an additional feature of an embodiment of the invention, the program code is further configured to cause a computer to load versioned objects corresponding to an effectiveness metric of the user based in part on the stored learning type.

In accordance with a further feature of an embodiment of the invention, the user database is a remote device.

Other modes and features that are considered as characteristic for the various embodiments of the invention are set fort in the appended claims. Although the invention is illustrated and described herein as embodied in the adaptive response/interpretive expression, communication distribution, and intelligent determination systems and methods, it is, nevertheless, not intended to be limited to the details shown because various modifications and structural changes may be made therein without departing from the spirit of the invention and within the scope and range of equivalents of the claims.

The construction and method of operation of the invention, however, together with additional features and advantages thereof, will be best understood from the following description of specific embodiments when read in connection with the accompanying drawings.

Adaptive Communication Environment Overview

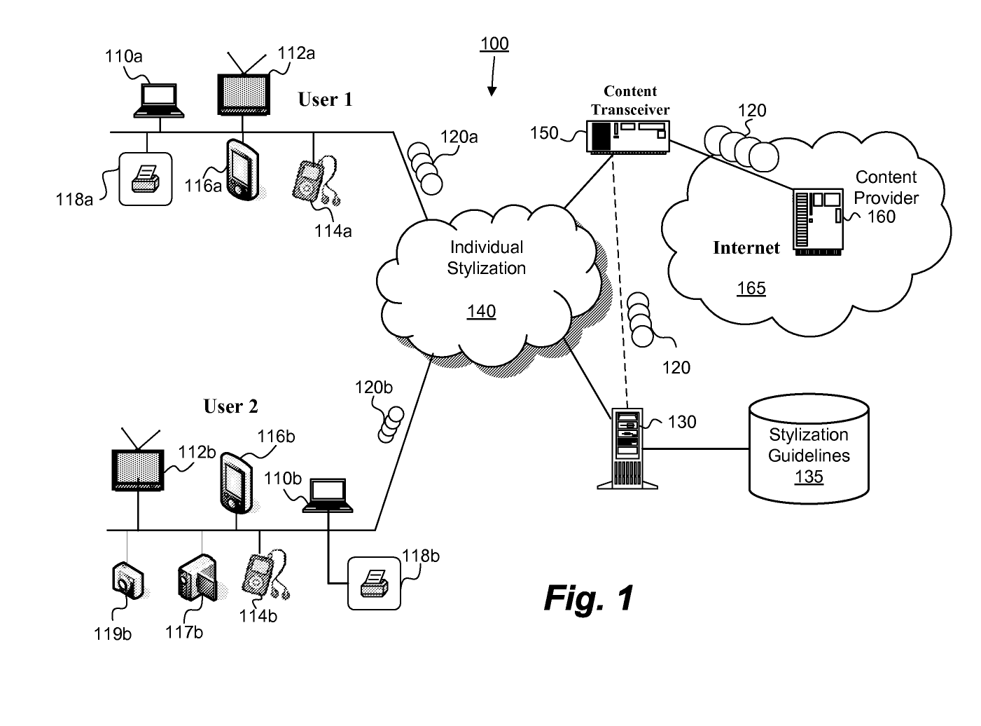

Referring now to FIG. 1, a block diagram illustrating an exemplar communications network 100 with adaptive leaning, communication distribution, and intelligent determination systems is shown. In one embodiment, the communications network 100 is configured to identify and classify cognitive processing preferences in individuals (User 1, User 2), The communications network 100 is also configured to develop informational content in al media forms, such as print, audio, visual, and the like, that appeal in substance and format to those individuals (User 1, User 2) identified according to at least one classification process. The communication network 100 includes digital devices for versioning content according to the identified classification of various cognitive processing preferences of individual users (User 1, User 2) by tagging content and automatically matching content to individual preferences.

The communication network 100 further incorporates a hierarchy of communication and heuristic learning principles that, when intermingled with content delivery method and software/web-based applications, convert ordinary thinking routines into an altered form of content enhancement tools capable of assisting the mind of a designated individual (User 1, User 2) and increasing the capacity for streamlined improvement in thought, communication, learning, and behavior with the designated individual (User 1, User 2). In one embodiment, unique editorial methods for developing stylized content objects according to corresponding cognitive types of the designated individual (User 1, User 2) are applied. Moreover, in one embodiment, a process referred to as content versioning, may be used for subsequent sorting (tagging) and classification of content in the system, Specifically, the communications network 100 includes at least one host platform 110a and/or 110b is coupled to a variety of different remote network devices (e.g., 112-165) via communications network 100.

The communications network 100 exchanges (transmits and receives) informational and interpersonal communication data 120 with a variety of network resources including a network versioning server 130 and content provider 160. The communications network 100 may also connect to a storage device containing tagged content database 155 and stylization guidelines 145. In one embodiment, at least one content provider 160 is accessible via communications network devices, such as versioning server 130, with access to the Internet 165, a worldwide, publicly accessible network of interconnected computer networks that transmit data by packet switching using standard communication protocols.

The network connections of the various network capable devices may be direct connections as illustrated by the connections associated with host platform 110a, media center 112a, personal multimedia device 114a, personal digital assistant 116a, and printer 118a of User 1. Indirect connections using another network capable device, as illustrated by the connections associated with the host platform 110b of User 2 connecting the media center 112b, the personal multimedia device 114b, personal digital assistant 116b, the video camera 117b, the printer 118b, and the camera 119b to the communications network 100. The communications network 100 may also include both wired and wireless connections to the different network devices (110-160).

Communications network 100 may handle a number of requests for informational and interpersonal communication data 120 to be automatically performed. For example, the user (user 1, user 2) may use a host platform (110a, 110b) or other device (112-119) coupled to the communications network 100 to request data 120 from content provider 160.

Once the data 120 is initially received by the versioning server 130, in one embodiment, the versioning server 130 individually stylizes the content (120a, 120b) based on the requesting device and user, In accordance with one embodiment, the versioning server 130 analyzes and converts the data 120 into stylized content 120a, 120b according to stylization guidelines 140 retrieved from a stylization database 145.

In one embodiment, the versioning server 130 upon receiving the original data request determines whether tagged data 150 is already available in a tagged content database 155. If tagged data 150 is available, the versioning server 130 applies any stylization guidelines 140 that may be applicable to create a custom content message with stylized content 120a, 120b for the requesting user (user 1, user 2) in at least one of the requested media forms, such as print, audio, visual, and the like. In one embodiment, the versioning server 130 may also verify that the stored tagged data 150 is still valid prior to use in stylized content.

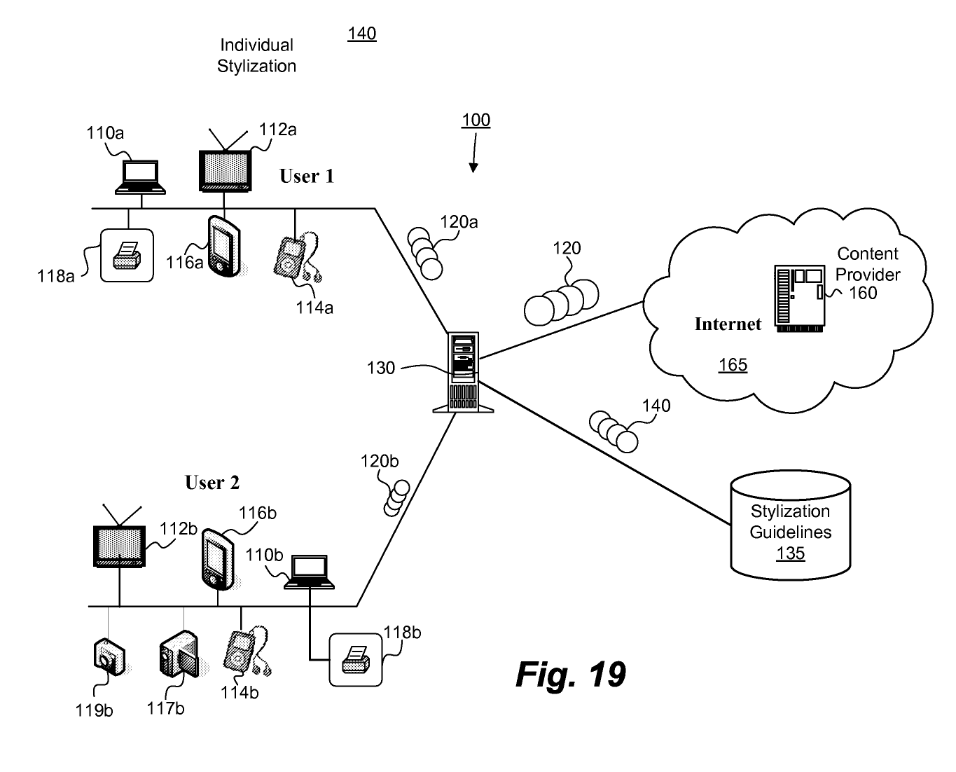

In an alternative configuration a centralized versioning platform server 130 may be used to stylize data sent to and from the users according to individual stylization preferences 140. The FIG. 19

FIG. 1 and FIG. 19 along with the following discussion are intended to provide a brief, general description and overview of a suitable environment that includes a network 100 and method for delivery of data and information or content, devised, reordered and repackaged for customized receipt by a customer.

The network 100 delivers principle enhanced content, which is based upon the preferences, tendencies, levels of experience, and/or the thinking, communication, and learning style of an individual customer. As used herein, a customer or user is an end user that has been identified and classified according to his or her cognitive processing type and is being presented with informational communications in any given media format that has been similarly categorized, due to its substance and/or format, to correspond to that person's identified cognitive processing type. Examples of customers might be: 1) students in a live classroom or instructional setting, 2) students interfacing with digital curriculum through computers and/or other multi-media delivery apparatus, 3) consumers receiving marketing pieces in the mail, such as letters, brochures, magazines, newspapers, 4) consumers on the internet being directed to designated web pages and/or receiving appropriately stylized e-mails, 5) employees receiving live or digital job training.

The process incorporates a hierarchy of communication and learning principles that, when intermingled with the content delivery methods and software and web-based applications, converts ordinary thinking routines to an altered form of enhancement tools capable of assisting the mind and increasing the capacity for streamlined improvement in thought, communication, learning, and behavior. The unique editorial method for developing stylized content objects according to corresponding cognitive types.

Versioning Platform System

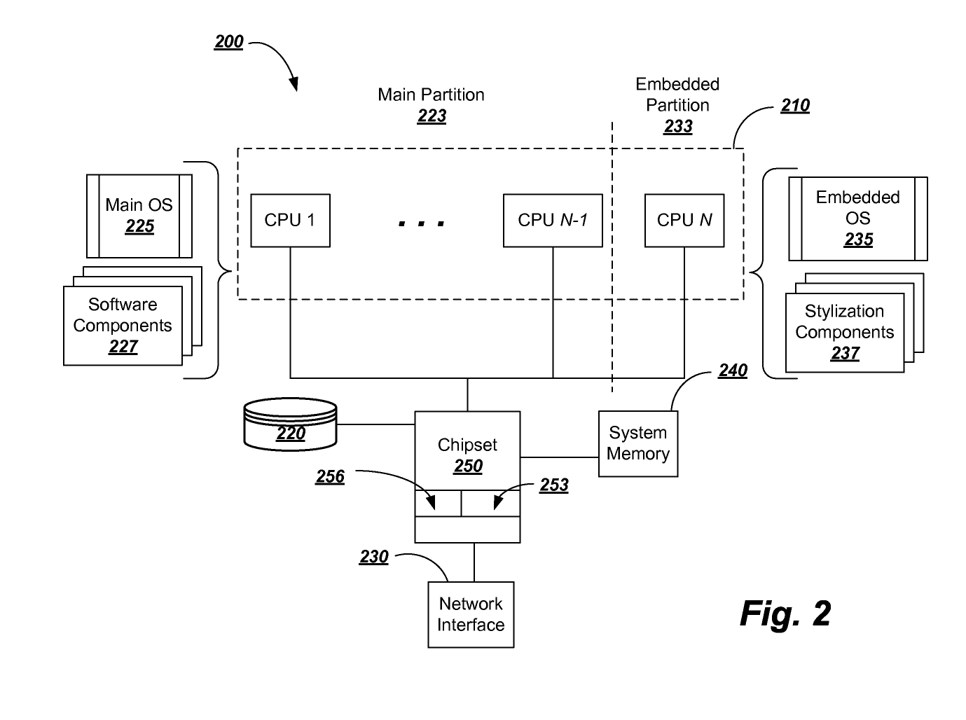

Referring to FIG. 2, a block diagram of a multi-processor host platform system 200 is shown in accordance with various embodiments. The system 200 includes a plurality of processors 210, a mass storage device 220, a network interface 230, memory 240, and a chipset 250, coupled to each other as shown. Alternatively, the system 200 could have a single processing unit. Various embodiments of the system 200 may include a digital device with a processing device that includes at least one processor. As such, the terms “processor”, as used herein, should be interpreted to mean an individual processor, firmware logic, reconfigurable logic, a hardware description language logic configuration, a state machine, an application-specific integrated circuit, a processing core co-disposed in an integrated circuit package with at least one other processing core and/or component, or combinations thereof.

With the features of at least one embodiment of the invention in view, there is also provided a versioning processor configured to generate stylized content, a networking interface coupled with the versioning processor and configured to couple to a network to receive data to be stylized from a remote device and to transmit the stylized content to a user of a designated cognitive type requesting the data, and persistent storage coupled to the versioning processor and adapted to store one or more stylization guidelines for available cognitive types.

In accordance with another feature of an embodiment of the invention, the persistent storage area is further configured to store an individual stylization guideline for the user of a designated cognitive type requesting the data. In accordance with a further feature of an embodiment of the invention, the designated cognitive type of the user may be a composite of available cognitive types and the individual stylization guideline may be a composite of one or more stylization guidelines for available cognitive types customized based on the designated cognitive type of the user.

In accordance with an added feature of an embodiment of the invention, there is provided a second persistent storage area adapted to store the stylized content.

In accordance with an additional feature of an embodiment of the invention, the versioning processor is further configured to analyze received data in accordance with assessment parameters of one or more stylization guidelines and to tag the data according to each stylization guideline. In accordance with yet an additional feature of an embodiment of the invention, the versioning processor is further configured to generate stylized content from the tagged data based in part on at least one stylization guideline. In accordance with again an additional feature of an embodiment of the invention, the at least one stylization guideline is an individual stylization guideline for the user requesting the data.

In one embodiment, the network interface 230 is configured to receive informational and interpersonal communication data 120 and to automatically version the data into stylized content according to stylization guidelines retrieved from the mass storage device 220 and/or memory 240 by either an embedded secondary processor of versioning partition 233 or a primary host processor of the main partition 223. The received data versioning information including at least one individual stylization guideline and information associate with a user of at least one designate cognitive type requesting the data to be automatically versioned by the multi-processor host platform system 200.

In one embodiment, the stylization components 237 include at least one individual stylization guideline based on an efficacy metric developed for the user of the at least one designated cognitive type. The stylization components 237 provide on a user by user basis for the developing of custom content, based in part on stored stylized content, and further include analyzing the stored stylized content and generating the custom content based on the individual stylization guideline. Accordingly, the generated content may be stored for future use in the mass storage device 220 and/or the memory 240.

The plurality of processors 210 are the primary resources allocated to the respective partitions and may include any variety of processors known in the art including, in one embodiment, processors having a plurality of processing cores. Additional or fewer processors may be used in various embodiments.

The plurality of processors 210 may also comprise an integrate circuit (IC), such as a semiconductor integrated circuit chip. The plurality of processors 210 may be logically and/or physically divide into a plurality of partitions. For example, in the illustrated embodiment, the plurality of processors 210 are selectively assigned to one of two partitions, a main partition 223 (CPU1, . . . , CPU N−1) or an embedded versioning partition 233 (CPU N). In one embodiment, the plurality of processors 210 have at least one first processing core (CPU1, . . . , CPU N−1) coupled, via chipset 250, with the network interface 230 and the mass storage device 220. Although the assignment of the processors 210 to a particular partition may be temporary, a subsequent reassignment of the processing core may necessitate a suitable isolation, authentication, and/or validation to maintain operational status of the embedded versioning partition from the operating system 225. For example, a processor may be reassigned though a sequestering process on device start-up prior to activation of the operating system. Alternatively, in one embodiment, the various processors 210 may be dedicated and/or permanently assigned to one of the available partitions.

The at least one primary host processor associated with the main partition 223 is adapted to execute the one or more software components 227 and the operating system 225 which may include, for example, a general operating system such as Windows® operating systems, Linux, etc. The at least one processor associated with the embedded versioning partition 233 is adapted to execute the one or more stylization components 237 to version communication data automatically. This configuration reduces the overhead on the main partition associated with versioning communication data. Alternatively, the stylization components 237 may also be performed by a primary host processor of the device using the main operating system 225 to complete versioning of communication data.

System memory 240 may include semiconductor firmware memory, programmable memory, non-volatile memory, read only memory, electrically programmable memory, random access memory, flash memory (which may include, for example, NAND or NOR type memory structures), magnetic disk memory, and/or optical disk memory. Either additionally or alternatively, memory 240 may comprise other and/or later-developed types of computer-readable memory. Machine-readable firmware program instructions may be stored in memory 240. As described below, these instructions may be accessed and executed by the main partition 223 and/or the embedded versioning partition 233 of host processor 210. Accordingly in one embodiment, memory 240 may be logically and/or physically partitioned. One partition of system memory may be used to store commands, instructions, and/or data for operation of the main partition 223 and the other partition of system memory may be capable of storing commands, instructions, stylization guidelines and/or data for operation of the embedded versioning partition 233.

Chipset 250 may also or alternatively include graphics memory, chipsets, I/O controller hub chipsets, and/or other integrated circuit chips, Chipset 250 may also include inter-partition bridge circuitry 256. “Circuitry”, as used in any embodiment herein, may comprise, for example, singly or in any combination, hardwired circuitry, programmable circuitry, state machine circuitry, and/or firmware that stores instructions execute by programmable circuitry. The inter-partition bridge circuitry 256 may be capable of providing communication between the main partition 223 and the embedded partition 233. Chipset 250 may also be coupled to a plurality of mass storage device 220.

In accordance with one embodiment, digital devices incorporating a multiprocessor host platform system, as described in FIG. 2, can be configured to perform the task of automatically versioning communication data to the host platform, Moreover the versioning server 130, in one embodiment, is a multiprocessor platform with at least one processor being configured to version generic content in accordance with assessment parameters of the stylization guidelines for at least one cognitive type, is further configured to store all the stylized content generated into centralized network attached storage (NAS) and the lie. Although illustrated as a component of the versioning server 130, the stylization guidelines 145 and tagged content database 155 may also be an independent remote network device or attached to another host platform.

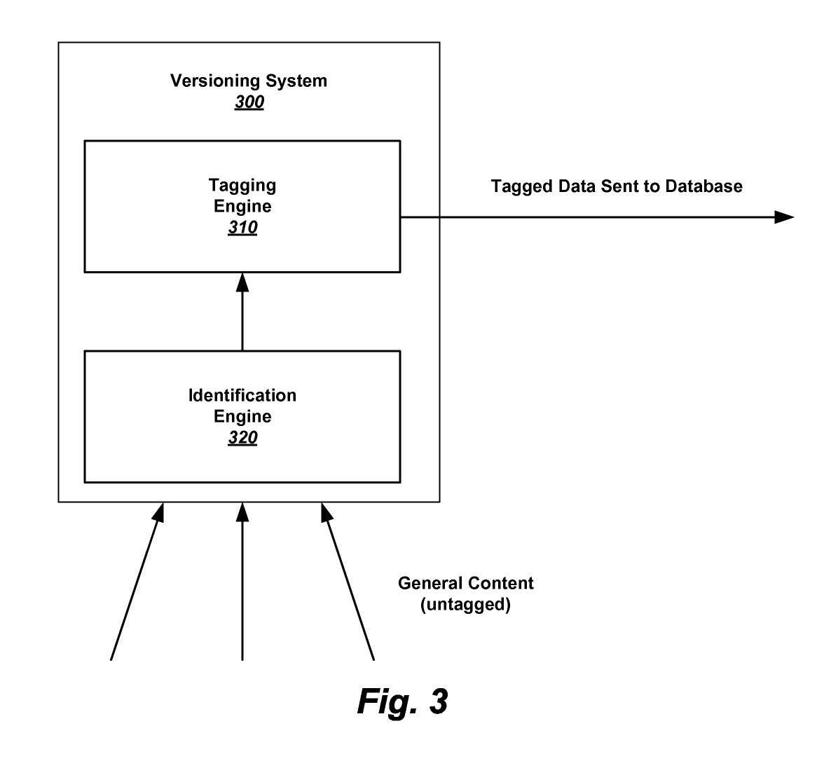

Referring to FIG. 3, a versioning system 300 in an adaptive response/interpretive expression, communication distribution, and intelligent determination systems environment as presented in FIG. 1 is illustrated in accordance with various embodiments. More specifically, FIG. 3 depicts a versioning system 300 including a tagging engine 310 and an identification engine 320. In one embodiment, the identification engine 320 is configured to receive general content or communication data that is untagged. One embodiment configures the identification engine 320 to compare the received un tagged content with various stylization guidelines and the tagging engine 310 to determine how the content should be tagged based in par on the stylization guidelines, Alternatively, the tagging engine 310 may also generate data for each category being identified and tagged. The tagging engine 310 receives blocks of untagged content from the identification engine and generates tagged data to be sent to a tagged content database.

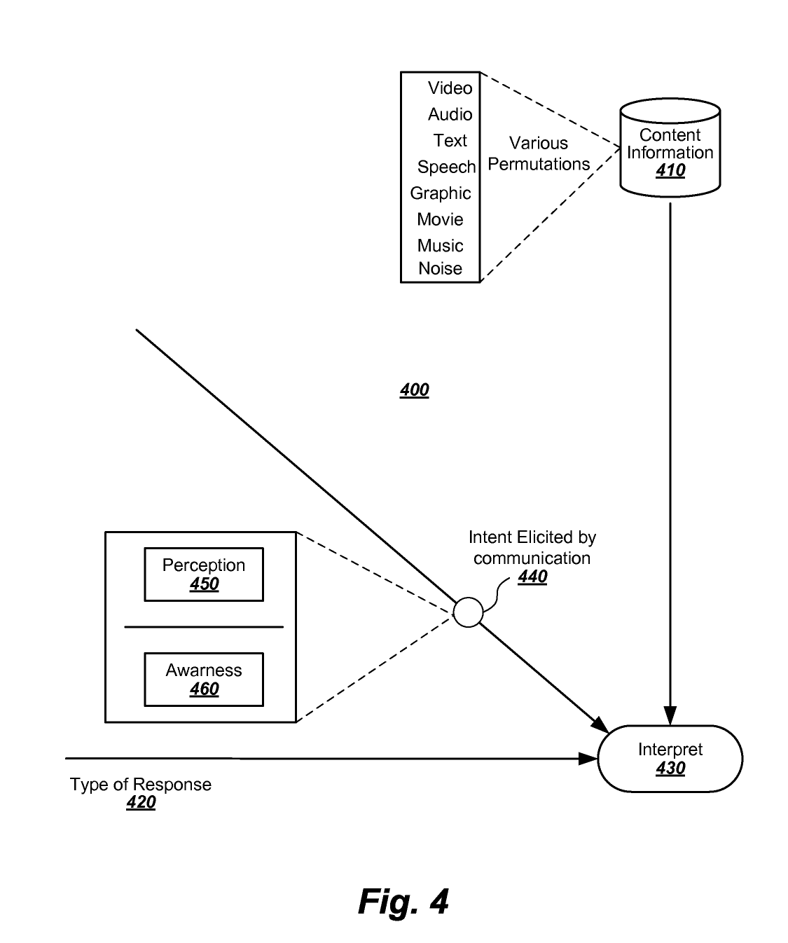

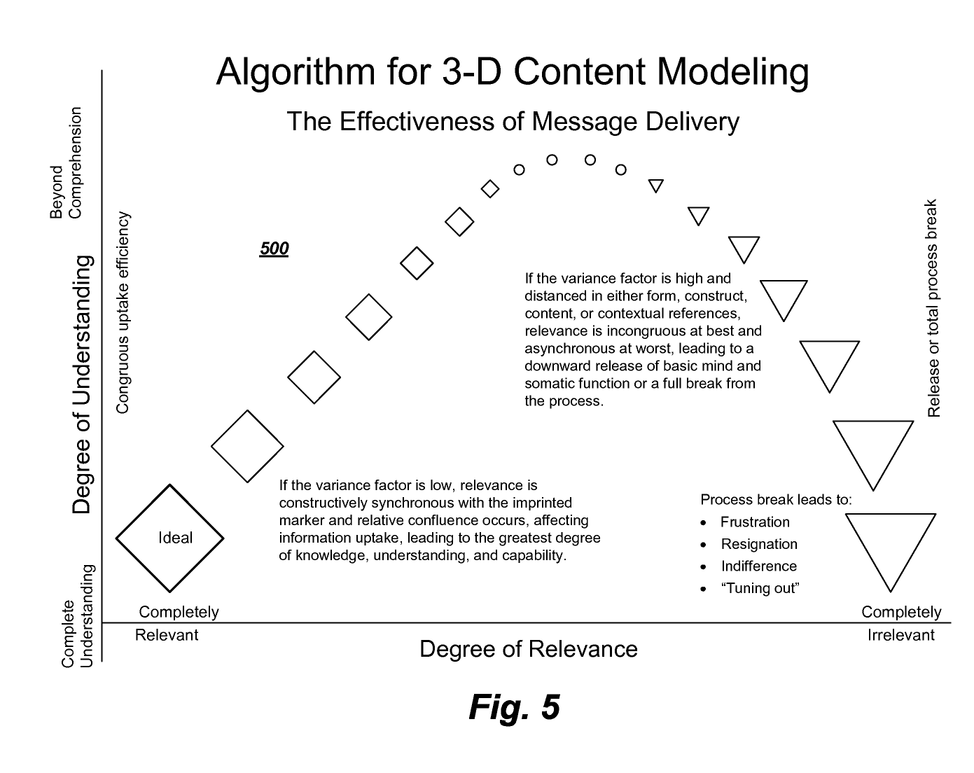

The versioning system 300 develops and delivers customized informational and interpersonal communications is described. The editing process is shown in FIG. 4 and FIG. 5 for developing and delivering custom content messages in all media forms according to defined stylization guidelines that optimize recipient comprehension, absorption, retention and positive responses to said messages in the areas of educational instruction, consumer direct marketing, hum resource training, organizational development and personal growth.

Referring to FIG. 4, a graph 40 shows elicited intent 440 as perceived by a user, The resulting user interpretation 430 being based on a desired response 420 to communication relative to actual content 410 of the communication. The relative effectiveness of a given communication or elicited intent 44 of the communication is based in part on the relative perception 450 versus awareness 460 of the user receiving the communication.

Referring to FIG. 5, a graph 500 shows an algorithm for content modeling that evaluates the relative effectiveness of message delivery. The effectiveness of a message is a relative comparison of the degree of understanding of the user relative to the degree of relevance of the subject matter. Thus, in a given subject matter a recipient may vary the degree of understanding between complete understanding and beyond comprehension. The content of the communication may vary the degree of relevance between completely relevant and completely irrelevant. Accordingly, when the variance factors are low, relevance is constructive synchronous with the imprinted marker and relative confluence occurs, affecting information uptake, leading to a greater degree of knowledge, understanding, and capability. If the variance factor is high and distanced in either form construct, content, or contextual, references, relevance is incongruous at best and asynchronous at worst, leading to a downward release of basic mind and somatic function or a full break from the process. A process break leads to frustration, resignation, indifference, and tuning out the information.

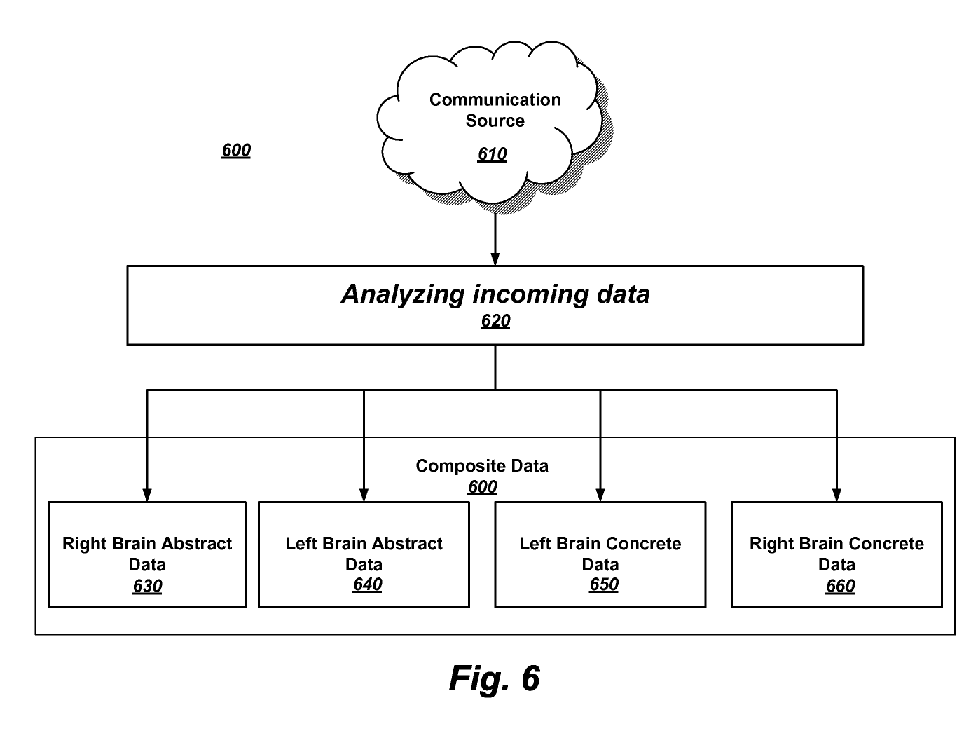

Referring to FIG. 6, a communication versioning system 600 in an adaptive response/interpretive expression, communication distribution, and intelligence systems environment as presented in FIG. 1 is illustrated, in accordance with various embodiments. More specifically, FIG. 6 depicts a communication source 610, such as the content provider 160, the Internet 165, and/or the tagged content database 155 providing incoming communication data to be analyzed in block 620, In one embodiment, the incoming communication data is analyzed relative to various cognitive learning types, Although the illustrated version indicated that there are four primary available cognitive types, other combinations of cognitive types are possible and are considered within the scope of the invention. In one embodiment, the four identified thinking segments are based on right brain concrete, right brain abstract, left brain concrete, and left brain abstract.

In one embodiment, synthesizer data 630 includes communication that presents the big picture; appreciates creativity and the use of analogies; prefers the presentation to be war and sensitive to the need of the user; and desires time to consider alternatives, In one embodiment, analyzer data 640 includes communication that explains “why”, provides the details, presents things in sequence, and explains the benefit of each point. In one embodiment, concluder data 650 includes communication that provides the reader with a bottom line, avoids repetition and excessive detail, and explains options clearly. In one embodiment, interactive data 660 includes communication that is friendly and conversational, uses anecdotes and humor, allows expression/reaction from the reader, and explains how it affects the reader. Once the data has been analyzed, composite data 670 is generated consisting of each part of the communication associated with the various available cognitive types.

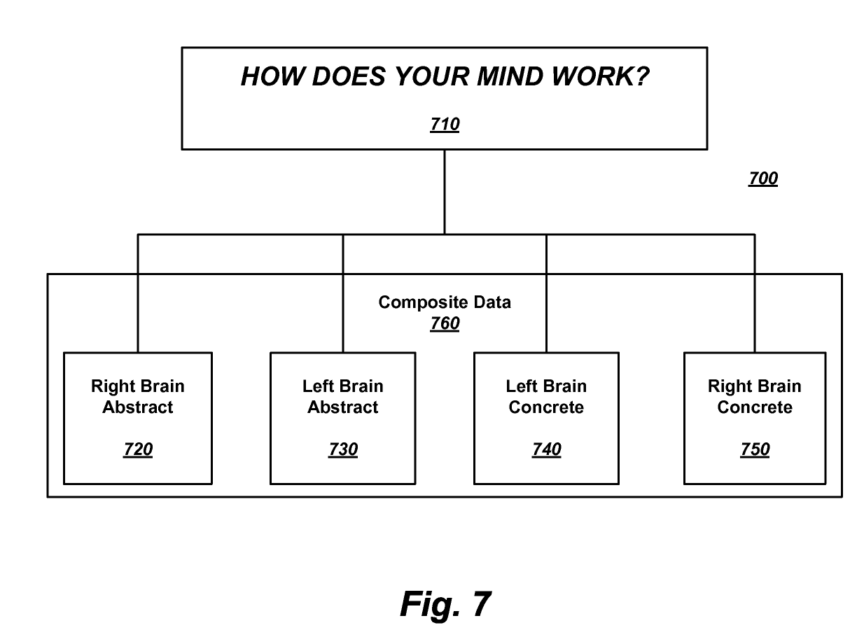

Referring to FIG. 7, a reader/user versioning system 700 in an adaptive response/interpretive expression, communication distribution, and intelligence systems environment as presented in FIG. 1 is illustrated, in accordance with various embodiments. More specifically, FIG. 7 evaluates how a user's mind works in block 710 to develop a corresponding individual stylization guideline for the user. In one embodiment, a user of at least one designated cognitive type may prefer at least one individual stylization guideline associated with composite data 760. The composite data 760 includes synthesizer parameters 720, analyzer parameters 730, concluder parameters 740, and interactor parameters 750.

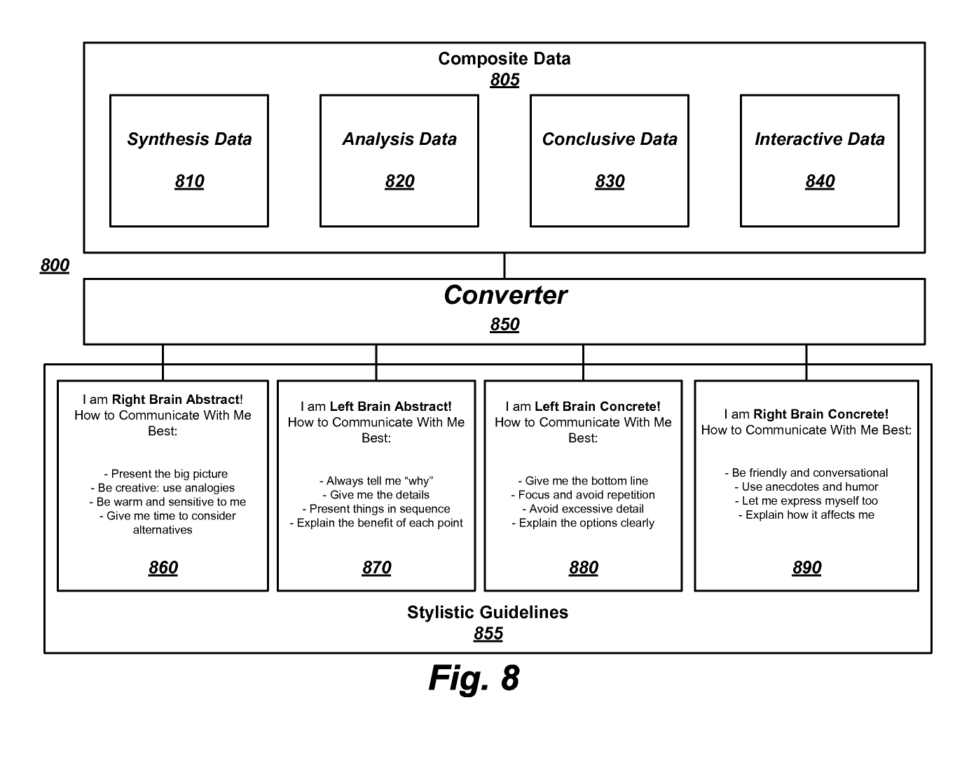

Referring to FIG. 8, a versioning server 800 in an adaptive response/interpretive expression, communication distribution, and intelligence systems environment as presented in FIG. 1 is illustrated in accordance with various embodiments. More specifically, FIG. 8 generates composite data 805 including synthesis data elements 810, analysis data elements 820, conclusive data elements 830, and interactive data elements 840. The versioning server 800 uses stylistic guidelines 855 to convert communication into composite data that is customized for effective user reception.

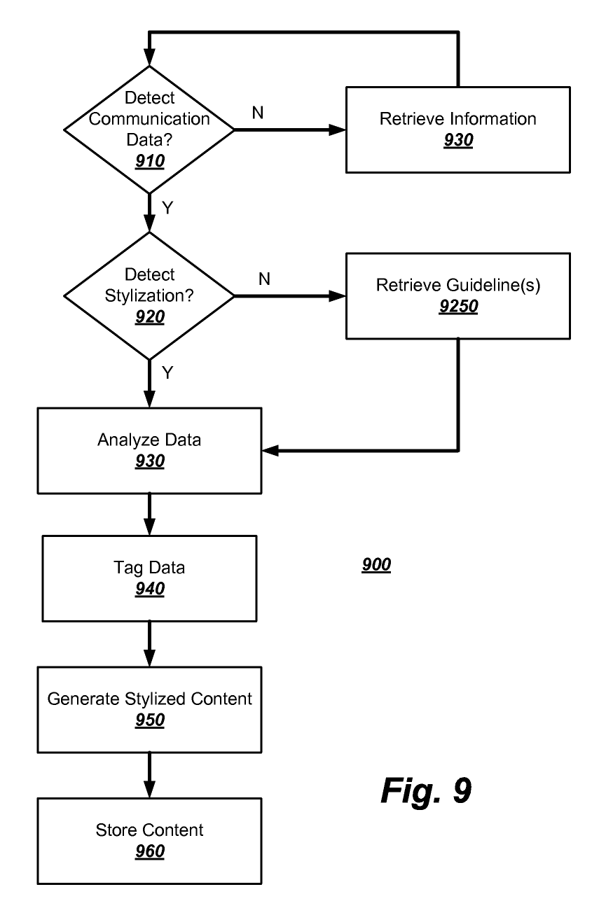

Turning now to FIGS. 9 to 11, methods, in accordance with various embodiments, are described in terns of computer firmware, software, and hardware with reference to a series of flow diagrams, In various embodiments, portions of the operations to be performed by a host platform device and/or remote devices may constitute state machines or computer programs made up of computer-executable instructions. These instructions are typically maintained in a storage medium accessible by the host platform device and/or remote devices.

Describing the methods by reference to a flow diagram enables one skilled in the art to develop such programs, including such instructions to carry out the methods on suitably configured host platforms and/or remote devices. In various embodiments, at least one of the processors of a suitably configured host platform and/or remote device executes the instructions from the storage medium. In various embodiments, the compute-executable instructions may be written in a computer programming language or may be embodied in firmware logic, reconfigurable logic, a hardware description language, a state machine, an application-specific integrated circuit, or combinations thereof. If written in a programming language conforming to a recognized standard, such instructions may be executed on a variety of hardware platform and may interface to a variety of operating systems.

In addition, the present invention is not described with reference to any particular programming language. It will be appreciated that a variety of programming languages may be used to implement the teachings of the embodiments as described herein. Furthermore, it is common in the art to speak of software in one form or another (e.g., program, procedure, process, application, etc.) as taking an action or causing a result. Such expressions are merely a shorthand way of conveying that execution of the software by a network device causes the processor of the computer to perform an action or produce a result.

With the foregoing and other features in view, there is provided, in accordance with at least one embodiment of the invention, a method for adaptive response/interpretive expression, communication distribution, and intelligent determination systems providing informational and interpersonal communication data and versioning the data into stylized content according to stylization guidelines.

In accordance with another mode of an embodiment of the invention, the versioning includes analyzing the data in accordance with assessment parameters of the stylization guidelines for available cognitive types, tagging the data according to each stylization guideline, and generating stylized content from the tagged data based in part on at least one stylization guideline. In accordance with a further mode of an embodiment of the invention, the versioning further includes storing the stylized content in a database for later delivery. In accordance with yet another mode of an embodiment of the invention, the method further includes developing custom content, based in part on the stored stylized content, in various media forms according to an individual stylization guideline associated with a user of at least one designated cognitive type requesting the data. In accordance with yet a further mode of an embodiment of the invention, the individual stylization guideline is based on an efficacy metric developed for the user of the at least one designated cognitive type and the developing of custom content, based in part on the stored stylized content, and includes analyzing on a user by user basis the stored stylized content and generating the custom content based on the individual stylization guideline.

In accordance with an additional mode of an embodiment of the invention, the versioning includes developing and/or delivering, based in part on the data, custom content in various media forms according to an individual stylization guideline associated with a user of a designated cognitive type requesting the data. In accordance with a concomitant mode of an embodiment of the invention, the providing includes receiving a data request from one or more users, each user having a designated cognitive type, to receive stylized messages based in part on the data being requested.

Referring to FIG. 9, a flow diagram view of a portion of the operations of a host device and/or system 900 as presented in FIG. 1 is shown in further detail, in accordance with various embodiments. Query operations of the system 900 in block 910 may include detecting communication data and requests for communication data. If no communication data is detected the system 900 retrieves data in execution block 915. If communication data is detected query operations of the system 900 in block 920 detect stylization guidelines. If the guidelines are not detected, the system 900 retrieves the guidelines in block 925. Otherwise the system 900 analyzes the data in block 930 in accordance with assessment parameters of the stylization guidelines for available cognitive types. The system 900 tags the data according to each stylization guideline in block 940. The system 900 generates stylized content in block 950 from the tagged data based in part on at least one stylization guideline. In block 960 the system 900 stores the stylized content in a database for later delivery.

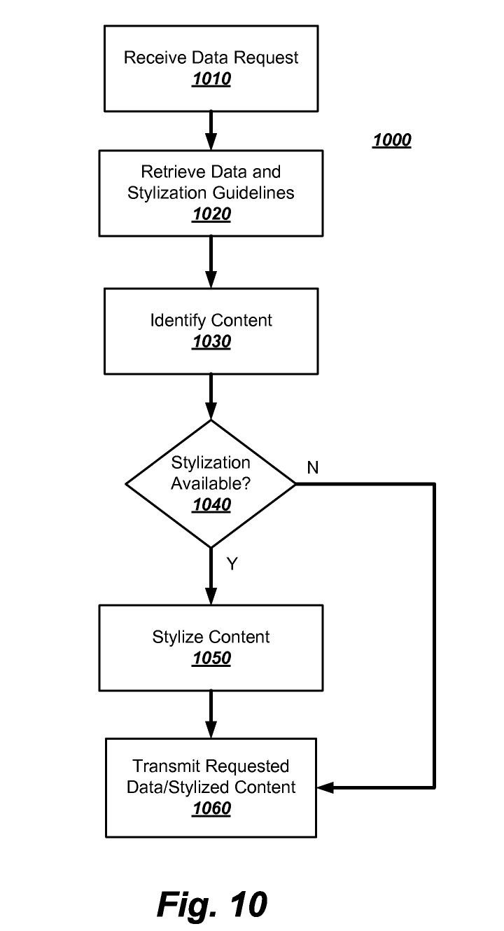

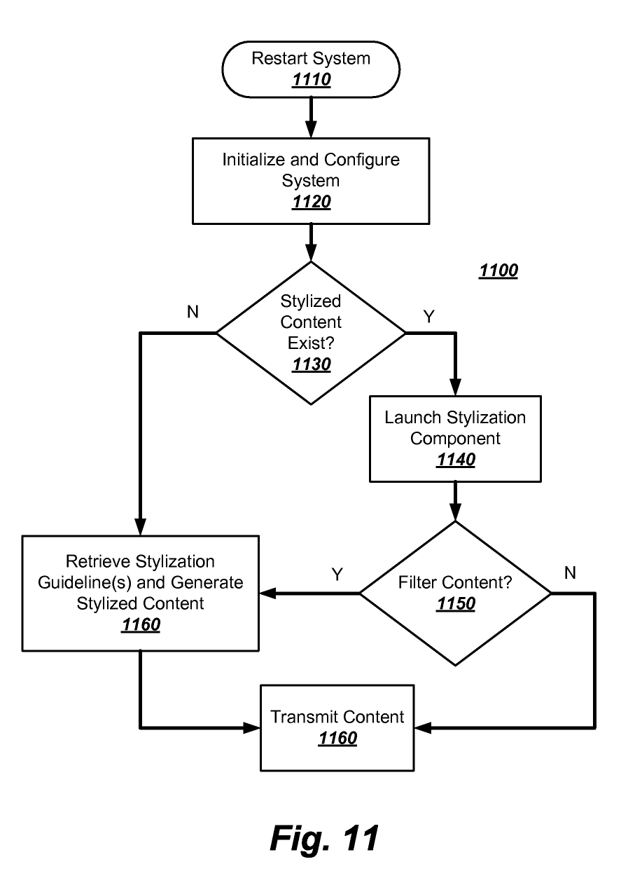

Referring now to FIGS. 10-11, flow diagram views of portions of the operations of a host device and/or systems 1000 and 1100 as presented in FIG. 1 are shown in further detail, in accordance with various embodiments.

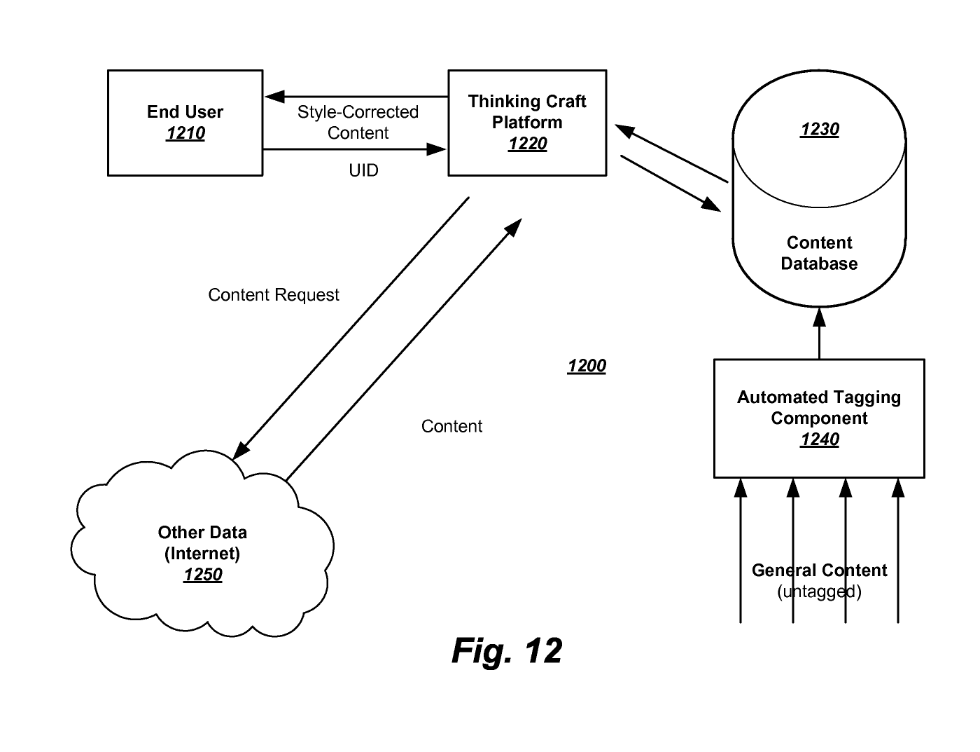

Referring now to FIGS. 12. 14, block diagrams of portions of the operations of a filters and/or automated versioning engines as presented in. FIG. 1 are shown in further detail, in accordance with various embodiments.

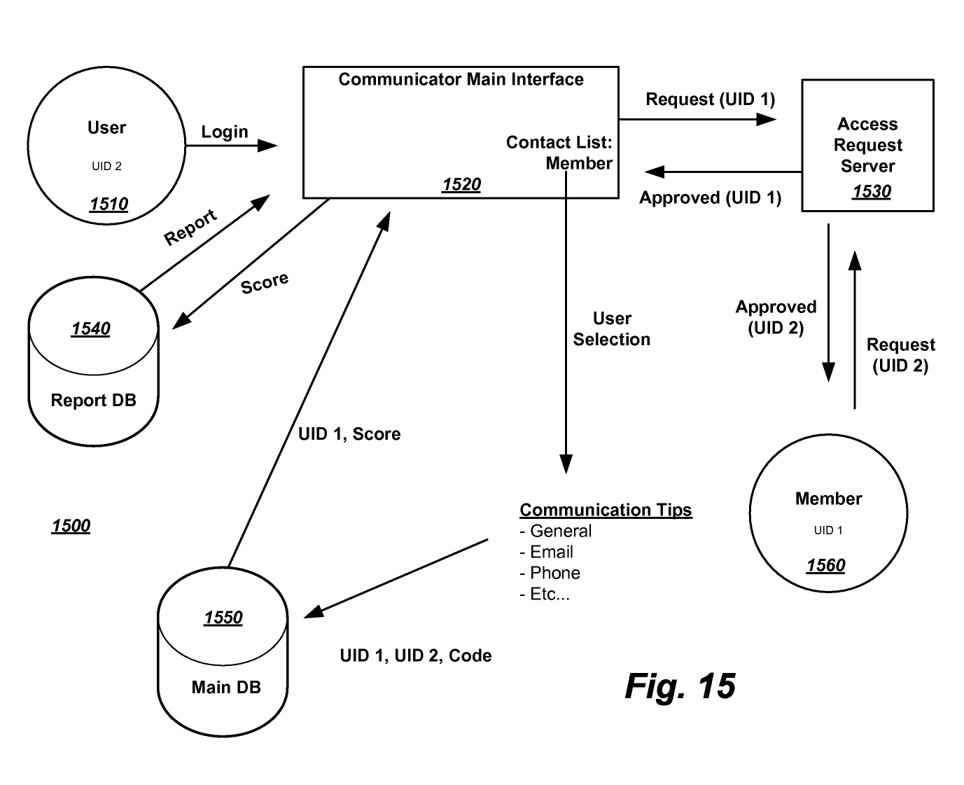

Referring now to FIG. 15, a flow diagram of adaptive response/interpretive expression, communication distribution, and intelligence systems for human resource training demonstrates communication tips and fulfillment, in accordance with at least one embodiment is shown.

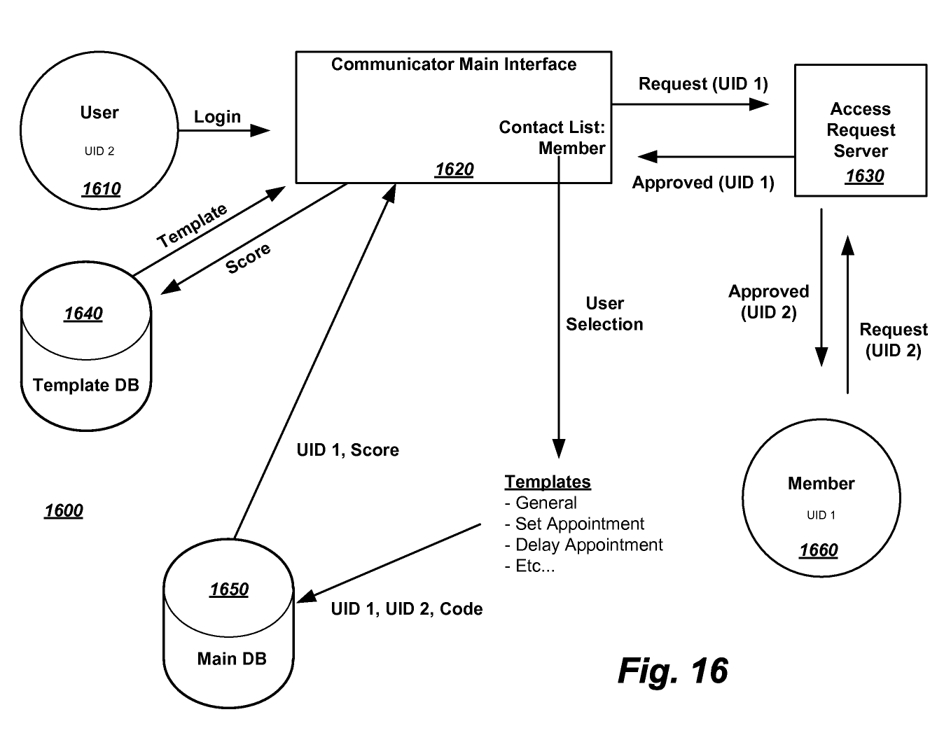

Referring to FIG. 16, a flow diagram of adaptive response/interpretive expression, communication distribution, and intelligence systems for organizational development including template request and fulfillment, in accordance with at least one embodiment is shown.

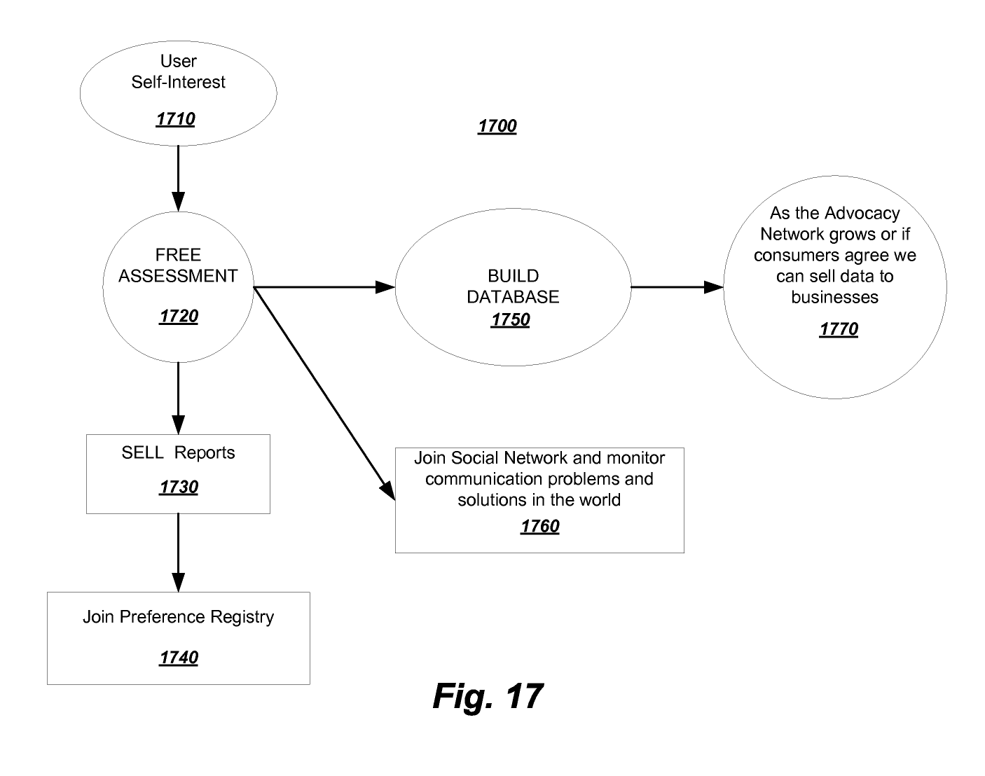

Referring to FIG. 17 a flow diagram of adaptive response/interpretive expression, communication distribution, and intelligence systems for personal growth, in accordance with at least one embodiment is shown.

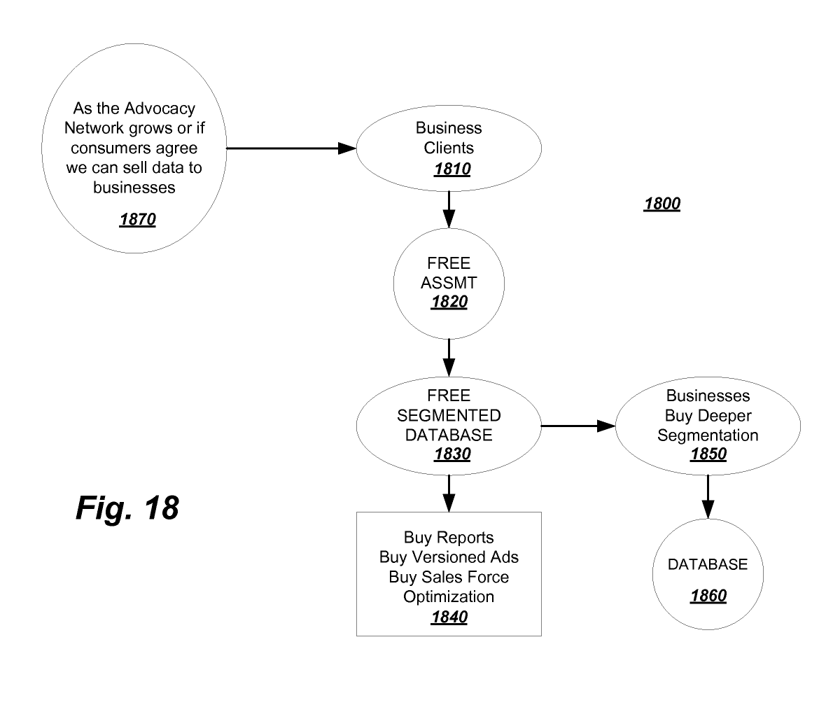

Referring to FIG. 18, a flow diagram of adaptive response/interpretive expression, communication distribution, and intelligence systems for consumer direct marketing, in accordance with at least one embodiment is shown.

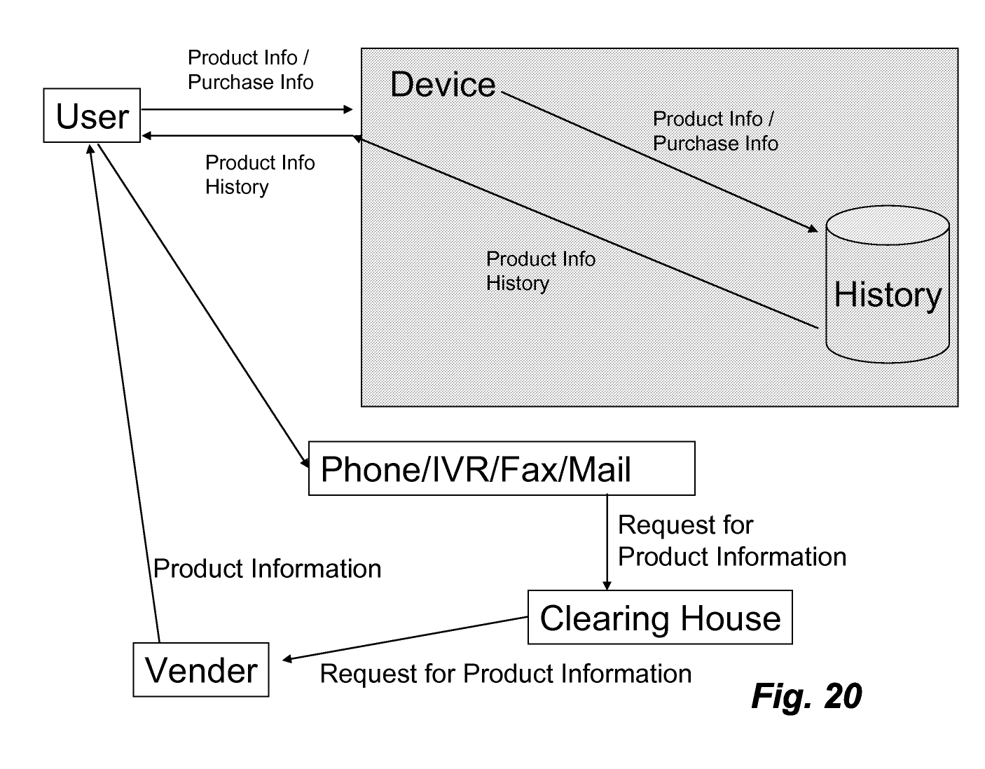

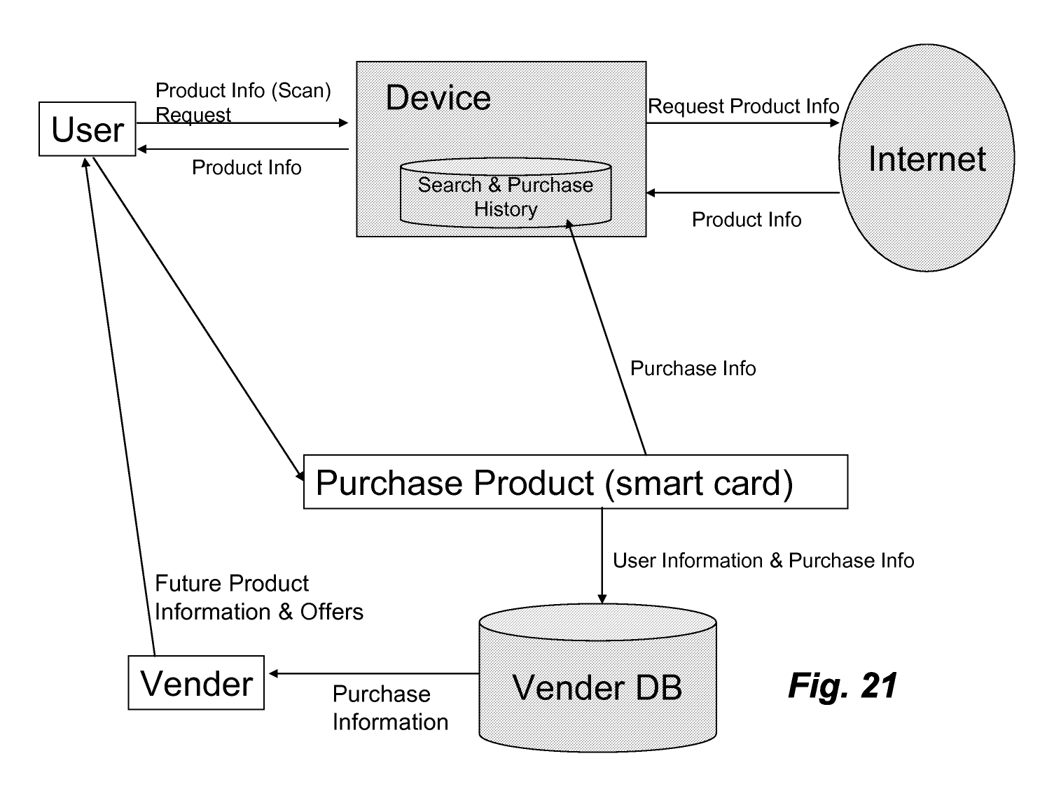

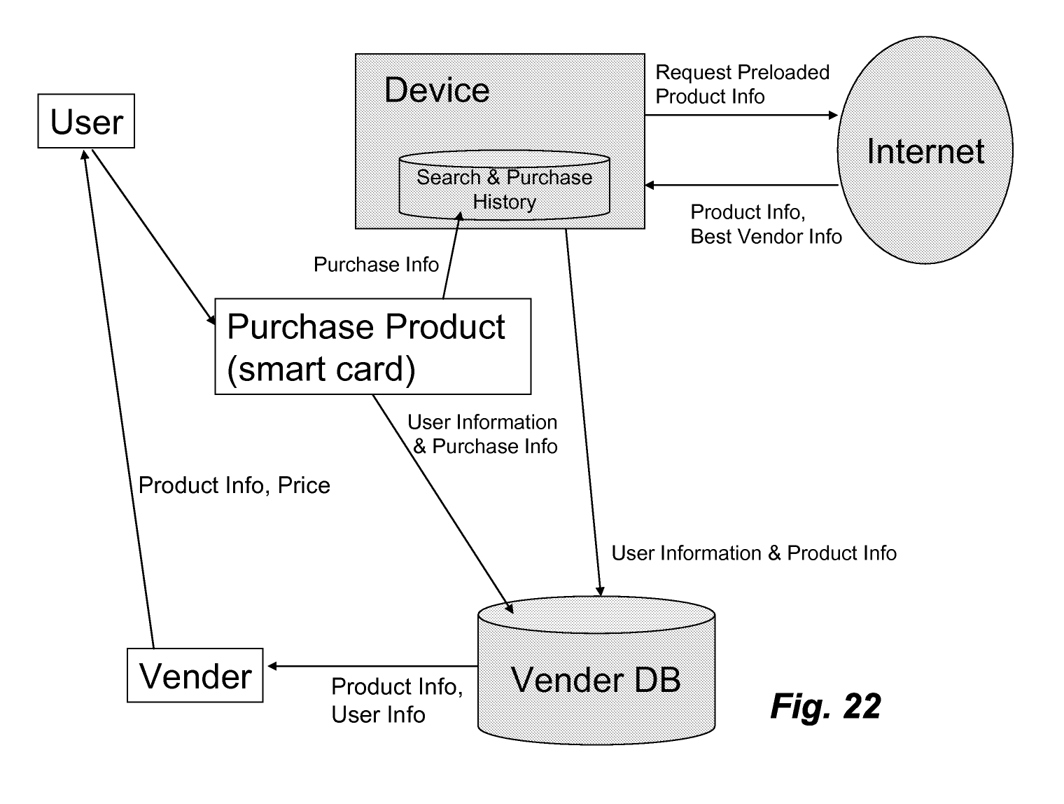

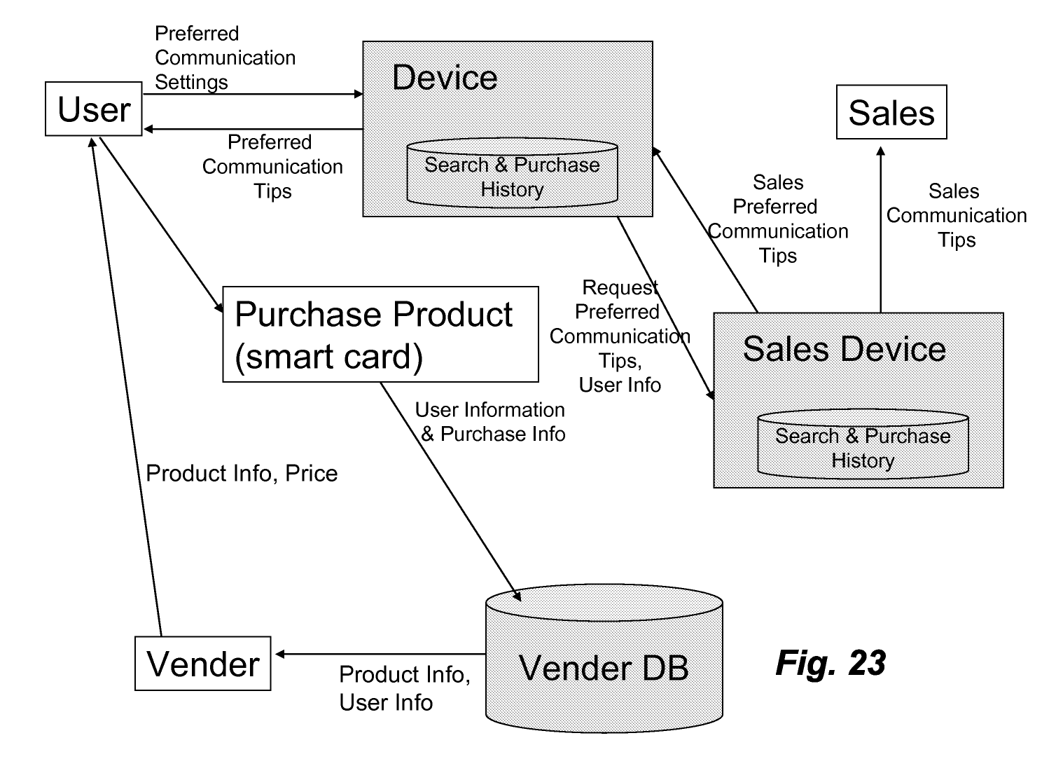

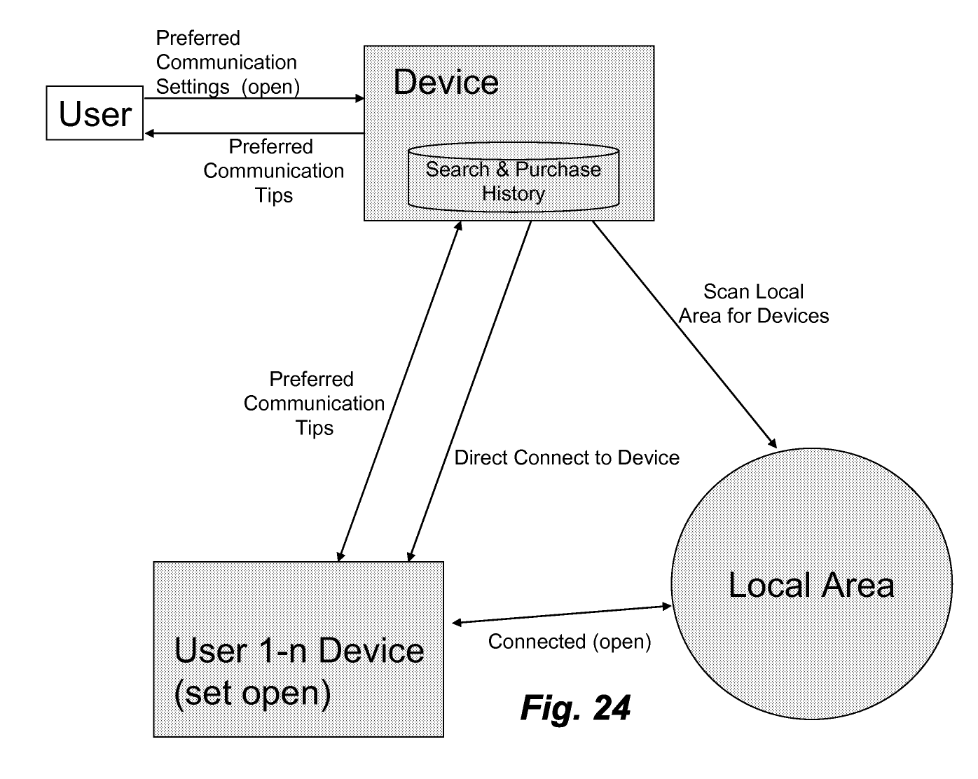

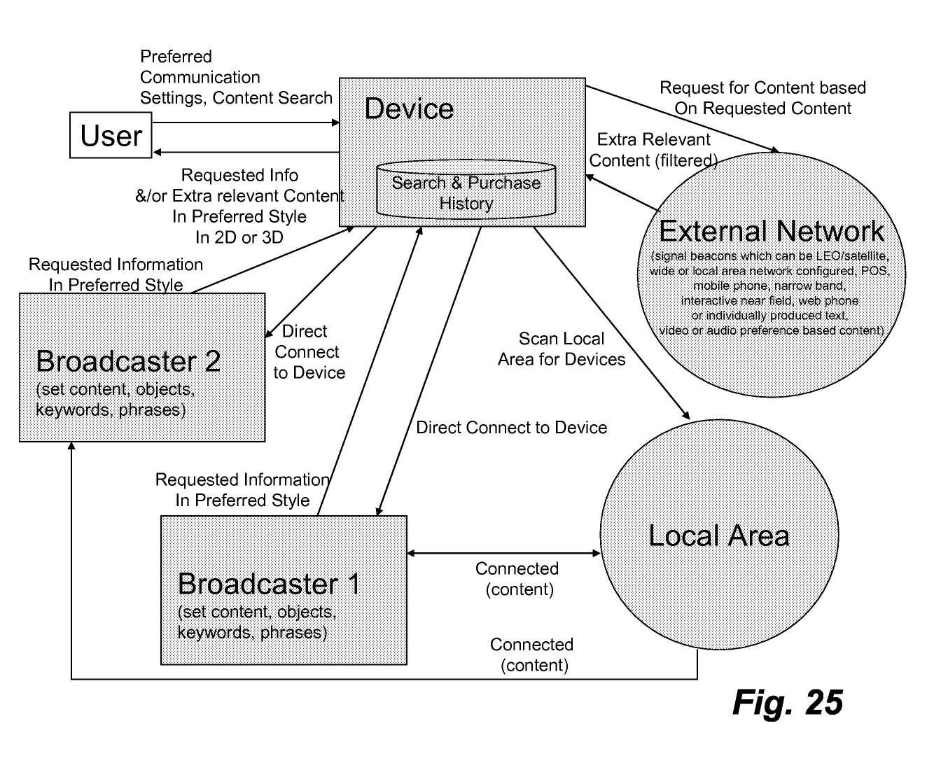

Referring to FIG. 20-25, block diagrams are illustrated of specific user communications devices as outlined in Table 1 below. Other communication device configurations considered within the scope of the disclosure include both a device and/or a plug-in for an existing computer and/or handheld/mobile device configured to vastly improve the means and methods of communications between individuals. For example, in addition to the providing communication tips and recommendations as previously described in FIG. 16, people who speak different languages may now communicate with one another using customized cognitive communication methods. A foreign language extension of the disclosure may use Natural Language engines installed in the device and/or accessible via the external network/local area network, as show in FIG. 25, to adapt to communication characteristics and tendencies of participating individuals. For example, communications conveyed in accordance with the digital technologies illustrated in FIGS. 24 and 25, enable a message from the transmitting individual to be generated for the receiving individual in a manner that would conform to the language of the receiving individual. Communication may also include embedded intelligence specific to the localization of certain traits found in either the culture and/or dialect of the broadcasting individuals, whether they be a sender (e.g., broadcaster 1) or receiver (e.g., broadcaster 2), of a message.

The device in FIGS. 24 and 25 may include a universal cognitive preference based language translator, which includes stored tendencies and characteristics of individuals, groups of individuals and/or categorizations of individuals that adjust communication to cultural, linguistic, language, dialect and relevant colloquial nuances so that incoming and outgoing messages are filtered by way of a preference leveling engine based on the cognitive hierarchy previously described in this application and that adapts outputs differentially so the intelligence contained in the subject matter, and communication style of the individual(s), groups of individuals or categorizations of individuals are automatically formulated and factored in communication sent and received by the sender (e.g., broadcaster 1) and the receiver (e.g., broadcaster 2) of a message.

The above specification, examples and data provide a complete description of the manufacture and use of the composition of the invention. Although specific embodiments have been illustrated and described herein, it will be appreciated by those of ordinary skill in the art and others, that a wide variety of alternate and/or equivalent implementations may be substituted for the specific embodiment shown in the described without departing from the spirit and scope or essential characteristics of the present disclosure. This application is intended to cover any adaptations or variations of the embodiments discussed herein. Therefore, the described embodiments are to be considered in all respects only as illustrative and not restrictive. Moreover, it is manifested and intended that the disclosure be limited only by the claims and the equivalence thereof. As such, the scope of the invention is indicated by the appended claims rather than by the foregoing description. All changes that come within the meaning and range of equivalency of the claims are to be embraced within their scope.

TABLE 1

| All Digital | | | | | |
|---|---|---|---|---|---|
| Displays | Modularized Authoring Set | Modularized Data | Modularized Data | Vendor | Vendor |
| Versioned | Preferences Mode | Collection Mode | Transmission Mode | Notification Mode | Transmit Mode |
| Level I | User types in product | Device Displays, by product, | User, by way of IVR | Clearinghouse | Vendors send product |
| Basic Item | classification, distributor | category or service, last price | inputs associated | notifies Vendors of | information with seal as |
| Collector | manufacturer Skew #, Model | previously paid for same or | product request based | User requests by | requested |
| | #, and if applicable User | similar product previously | on previous criteria or | product type, | |
| | states the color code on the | purchased, including, | mails or faxes to a data | service | |
| | receive and transmit level* | quantities purchased and | clearinghouse. | classification | |
| | | monthly and yearly averages | | | |
| Level II | User inputs to PC product | Price paid by other users | Smart Card is pre- | POS/Direct Mail/ | Incentives and |
| | skew or chooses product | displayed by zip code, city, | inserted prior to ATM or | Catalogue/Tele- | premiums applied as |
| | from drop-down list or; scans | country, state, nation or on | Credit Card transaction | marketing Order | requested by user, as |
| | Bar Code or receives Beacon | the web with auto inventory | which stores | Conversion Tool** | made available by |
| | signal at Point of Sale (POS), | calculator displayed to User | information and | activated | vendors |
| | or; inputs custom vendor | | transmits to central | | |
| | generated marker from direct | | vendor data base | | |
| | mail piece or catalogue at | | | | |
| | home or work location | | | | |
| Level III | Product, category or service | Search results are displayed | Wireless device | POS/Direct Mail/ | Incentives, premiums |
| | preferences are pre-loaded | or, if mobile, Near field | uploads data | Catalogue/Tele- | and auction bidding |
| | and device scans available | technology identifies and | automatically to central | marketing and online | platforms applied as |
| | local and online vendor | collects product or service | vendor database | orders associated | requested by user, as |
| | sources. | code | | with variable | made available by |
| | | | | pricing component | vendors |
| Level IV | Depending on the setting or | Device displays information | If transmission line is | POS/Direct Mail/ | Incentives, premiums |
| | circumstance, user sets | based on user and situational | open at full disclosure, | Catalogue/Tele- | and auction bidding |
| | parameters for which type of | circumstances based on user | user device sends | marketing and online | platforms and Help Desk |
| | device holder is preferred and | preferences [Strengths and | recommendations for | order is placed and | data transmitted to user |
| | once identified, presses | limitations prompts activated | optimized | Automated Style- | |
| | appropriate color and selects | or deactivated] | communication to | based Vendor Help | |
| | situation or setting which | | device holder | Desk activated. | |
| | generates appropriate | | | | |
| | wizards and templates. | | | | |
| | Device holder follows the | | | | |
| | same procedure. | | | | |
| Level V | User sets device to Full Open | Device scans for all, or for | Live automatic 2-way | Optimization of | Process: |
| | Status (all device holders) or | other preferred, like setting | communication/real- | message and | 1. Salesperson takes |
| | Partial Open Status (i.e. only | compatible device holders | time device interaction | Buying Tips to | assessment. |
| | analyzers filtering out | (i.e. on showroom floor, | occurs with device | user; avoid and | 2. Salesperson receives |
| | concluders, synthesizers and | analyzer preferred, yet no | generated or | alert codes are | results about |
| | interactors) User has option | interactor) | customized tips or | displayed and | themselves and their |
| | to create customized | | personal reminders (i.e. - | preference | own natural style of |
| | messages or create their own | | Remember, you tend | blending occurs on | presentation. |
| | personalized tips for various | | to be impressed with | the user side in the | 3. Salesperson registers |
| | situations and settings | | analyzers, don't buy till | event there are | potential prospects that |
| | | | you try). | more than one | he will be visiting in the |
| | | | | salesperson to deal | system. |
| | | | | with. | 4. Each visit can be to |
| | | | | | one or two prospects. |
| | | | | | 5. Prior to visit or during |
| | | | | | visit the prospect(s) can |
| | | | | | take the assessment via |
| | | | | | the web or IVR. |
| | | | | | 6. Salesperson is |
| | | | | | delivered a report of |
| | | | | | how to modify his |
| | | | | | presentation to match |
| | | | | | the individual or |
| | | | | | combined assessments |
| | | | | | of the prospects. This |
| | | | | | arrives in his e-mail, via |
| | | | | | SMS or other delivery to |
| | | | | | personal wireless |
| | | | | | devices, and on the |
| | | | | | web. |
| Level VI | User (Broadcaster) preloads | Depending on user generated | IP address based | Levels set for | The further filtering in or |
| | key words, phrases and | settings, (i.e. - at a | transmission of | ranges of | filtering out of categories |
| | concepts, (content or content | participating vendor in the | versioned content to | transmission (i.e.- | of content from |
| | objects) which are | preference-based vendor | wireless hand-held | News cast where | broadcasters based on |
| | synchronized and edited by | network, another user that | device, with 2-way or | filtering out of all | pre-stimulus activity to |
| | user and then associated with | has been added to the user's | preference (3D) | violence related | include only those |
| | the appropriate meaning | contact list in a situational | blending components | segments are | categories predicted to |
| | converter based on the | template supported social, | activated for | eliminated from the | be of interest based on |
| | setting; (i.e. - work home, | familial, academic, | simultaneous | transmission tray | the thinking style of the |
| | classroom) and range of | commercial or business | interaction among other | for a particular | user/receiver and/or |
| | styles the user desires to | setting), device allows inputs | users in the network of | broadcast to a user | blended with the content |
| | communicate to other device | from product, concept or | with the Broadcaster. | or the filtering out | desired or historically |
| | holders. | brand-based, signal beacons | Configured to interface | of all movies that | selected by the user/ |
| | | which can be LEO/satellite, | with mobile phones, | are not rated G or | receiver (i.e. only |
| | | wide or local area network | radio, TV, and/or web | PG) | insurance, auto and |
| | | configured, POS, mobile | based platforms with | | food ads; or only |
| | | phone, narrow band, | select transmissions | | insurance, auto and |
| | | interactive near field, web | containing pre-loaded, | | food ads that are |
| | | phone or individually | style-based content | | humorous or all ads, |
| | | produced text, video or audio | which triggers the | | regardless of category |
| | | preference based content. | delivery of the | | that are humorous) |
| | | | receivers preferred | | |
| | | | content which is based | | |
| | | | on the receivers | | |
| | | | Thinking Style and/or | | |
| | | | the modes | | |
| | | | transmission mediums. | | |

What is claimed is:

1. A method comprising:
providing informational and interpersonal communication data; and
versioning the data into stylized content according to stylization guidelines.

2. The method as recited in claim 1, wherein the versioning comprises:
analyzing the data in accordance with assessment parameters of the stylization guidelines for available cognitive types;
tagging the data according to each stylization guideline; and
generating stylized content from the tagged data based in part on at least one stylization guideline.

3. The method as recited in claim 2, wherein the versioning further comprises storing the stylized content in a database for later delivery.

4. The method as recited in claim 3, wherein the method further comprises developing custom content, based in part on the stored stylized content, in various media forms according to at least one individual stylization guideline associated with a user of at least one designated cognitive type requesting the data.

5. The method as recited in claim 4, wherein the individual stylization guideline is based on an efficacy metric developed for the user of the at least one designated cognitive type and the developing of custom content, based in part on the stored stylized content, includes analyzing on a user by user basis the stored stylized content and generating the custom content based on the individual stylization guideline.

6. The method as recited in claim 1, wherein the versioning includes developing and/or delivering, based in part on the data, custom content in various media forms according to an individual stylization guideline associated with a user of a designated cognitive type requesting the data.

7. The method as recited in claim 1, wherein the providing include receiving a data request from one or more users, each user having a designated cognitive type, to receive stylized messages based in par on the data being requested.

8. An apparatus comprising:
a versioning processor configured to generate stylized content;
a networking interface coupled with the versioning processor and configured to couple to a network to receive data to be stylized from a remote device and to transmit the stylized content to a user of a designated cognitive type requesting the data; and
a persistent storage area coupled to the versioning processor and adapted to store one or more stylization guidelines for available cognitive types.

9. The apparatus as recited in claim 8, wherein the persistent storage area is further configured to store an individual stylization guideline for the user of a designated cognitive type requesting the data.

10. The apparatus as recited in claim 9, wherein the designated cognitive type of the user may be a composite of available cognitive types and the individual stylization guideline may be a composite of one or more stylization guidelines for available cognitive types customized based on the designated cognitive type of the user.

11. The apparatus as recited in claim 8, wherein the versioning processor is further configured to analyze received data in accordance with assessment parameters of one or more stylization guidelines and to tag the data according to each stylization guideline.

12. The apparatus as recite in claim 11, wherein the versioning processor is further configured to generate stylized content from the tagged data based in part on at least one stylization guideline.

13. The apparatus as recited in claim 12, wherein the at least one stylization guideline is an individual stylization guideline for the user requesting the data.

14. The apparatus as recited in claim 8, wherein the apparatus further comprises a second persistent storage area adapted to store the stylized content.

15. A computer readable medium having computer program code embodied therein for causing one or more electronic computer systems to provide information, said computer program code comprising:
program code configured to cause a computer to determine a learning type of a user;
program code configured to cause a computer to store an indication of the learning type of the user in a set of one or more predetermined directories within a user database;
program code configured to cause a computer to match the stored learning type of the user within the user database with versioned objects for the stored learning type; and
program code configured to cause a computer to load versioned objects corresponding to the learning type of the user.

16. The computer program code as recited in claim 15, wherein the versioned objects are stored within a content database of the stored learning type.

17. The computer program code as recited in claim 16, wherein the content database is a remote database on one or more remote electronic computer systems in communication with the one or more electronic computer systems executing the computer program code.

18. The computer program code as recited in claim 15, wherein the user database is a remote device.

19. The computer program code as recited in claim 15, wherein the program code configured to cause a computer to match stored learning type with versioned objects includes:
program code configured to analyze generic data in accordance with assessment parameters of stylization guidelines for available learning types;
program code configured to tag the data according to each stylization guideline; and
program code configured to generate versioned objects from the tagged data based in part on at least one stylization guideline.

20. The computer program code as recited in claim 19, wherein the program code is further configured to cause a computer to load versioned objects corresponding to an effectiveness metric of the user based in part on the stored learning type.
